(19) United States
(12) Patent Application Publication
(10) Pub. No.: US 2024/0308738 A1
(43) Pub. Date: Sep. 19, 2024

(54) RUBBER SEALING ELEMENT FOR A PLASTIC CLOSING DEVICE FOR PARENTERALLY ADMINISTRABLE DRUGS

(71) Applicant: BISIO PROGETTI S.P.A., Alessandria (IT)

(72) Inventor: Bruno ROSSI, Alessandria (IT)

(21) Appl. No.: 18/271,537

(22) PCT Filed: Jan. 18, 2022
(86) PCT No.: PCT/IB2022/050395

§ 371 Date: Jul. 10, 2023

(30) Foreign Application Priority Data
Feb. 12, 2021 (IT) 102021000003191

(51) Int. Cl. B65D 51/00; A61J 1/14

(52) U.S. Cl. CPC B65D 51/002; A61J 1/1406

(57) ABSTRACT

A rubber sealing element for a plastic closing device is provided. The rubber sealing element has a discoidal cap head under which a cylindrical cap body extends, and a pierceable portion arranged in the center of the discoidal cap head. The discoidal cap head defines a head plane, and the pierceable portion is arranged on a raised plane with respect to the head plane. Advantageously, the rubber sealing element is easily accessible for disinfection.

The present invention relates in general to the field of closures of containers, generally in the form of vials or bottles, for pharmaceutical products, and in particular to the field of parenterally administrable drugs.

The subject of the present invention is a rubber closure, usually referred to as a “stopper,” for a plastic closing device, partially removable by tearing.

Caps are known in the art for further sealing a container, generally a vial in the form of a glass bottle, which is already sealed by a rubber closure. In such known solutions, the cap entirely covers the rubber closure.

In caps for parenterally administrable drugs, it is essential that the rubber closure remains firmly pressed into the container neck. In the case of parenterally administrable drugs, in fact, only the upper portion of the cap may be opened, for example by tearing, to allow exposure of the upper part of the rubber closure intended to be pierced by the needle of a syringe, used to withdraw the pharmacological solution contained inside the container.

Solutions of plastic caps for parenterally administrable drugs are known in the art. Such an example is described in document US 2016/184182 (A1), in which the cap comprises an upper portion which may be opened to expose the pierceable area of the rubber closure, and a fixed lower portion to keep the rubber closure firmly in the sealing position. In this solution, the fixed portion is snap-engaged to the edge of the container neck and extends to cover the entire neck. While this solution reduces the risks of tampering, given that it is difficult to access under the cap to try to tamper with it, it still has some drawbacks. In fact, the rubber closure is kept in position under the cap by means of a frictional engagement obtained through a thin crest which defines the pierceable area of the rubber closure inside it. Not only could such thin crest easily deform, making the engagement between the closure and the cap cease to exist during the assembly step on the container, but the extreme proximity to the pierceable area entails a certain risk of contamination of the same. Furthermore, since the rubber closure is arranged below the fixed portion of the cap, once the opening portion has been removed, the pierceable area of the rubber closure is accessible only through a small upper opening of said fixed portion. Therefore, the pierceable area is positioned on the bottom of the cap opening and is difficult to access for the necessary disinfection by the operator before using the sampling needle.

The object of the present invention is to provide a rubber sealing element for a plastic closing device for parenterally administrable drugs which solves the problems of the prior art taking into account the needs of the field.

In particular, the object of the present invention is to provide a rubber sealing element for a plastic closing device for parenterally administrable drugs, which is easily accessible for the necessary disinfection.

Another object of the invention is to provide a rubber sealing element with a retaining system under the cap which is effective and safe.

Such object is achieved by a rubber sealing element for a plastic closing device for parenterally administrable drugs according to claim 1 and by a safety container according to claim 8. The dependent claims describe preferred embodiments of the invention.

The features and advantages of the rubber sealing element according to the present invention will appear more clearly from the following description, made by way of an indicative and non-limiting example with reference to the accompanying figures, in which:

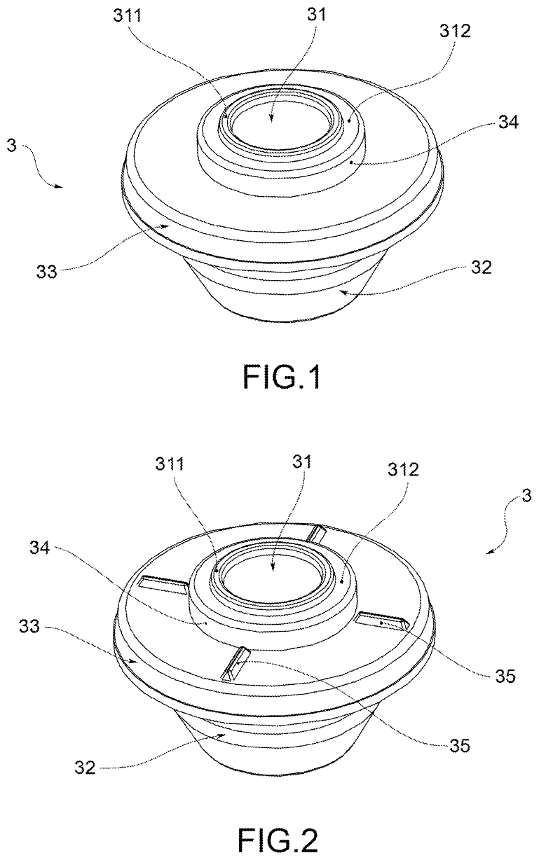

FIG. 1 shows a rubber sealing element for a plastic closing device for parenterally administrable drugs according to the present invention, in an embodiment example;

FIG. 2 shows a rubber sealing element for a plastic closing device for parenterally administrable drugs according to the present invention, in a further embodiment;

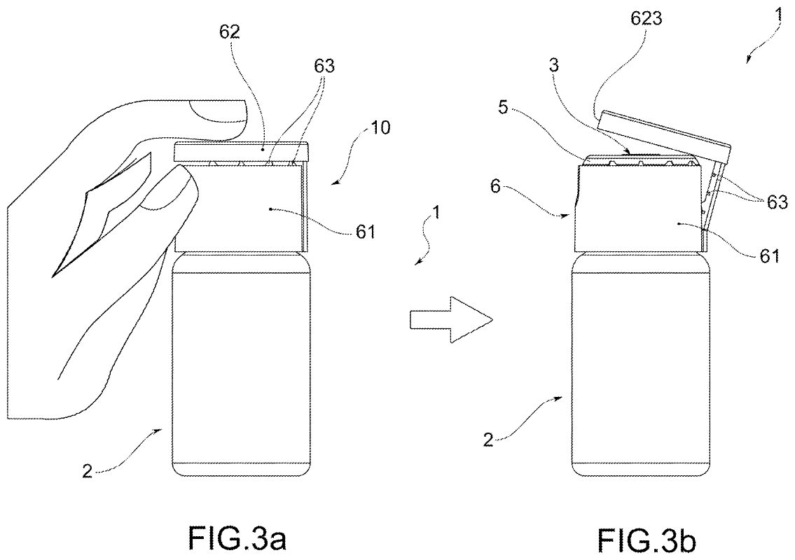

FIGS. 3A and 3B show the opening steps of a container provided with a rubber sealing element according to the present invention, in particular the tear-off removal of an outer cap of the plastic closing device;

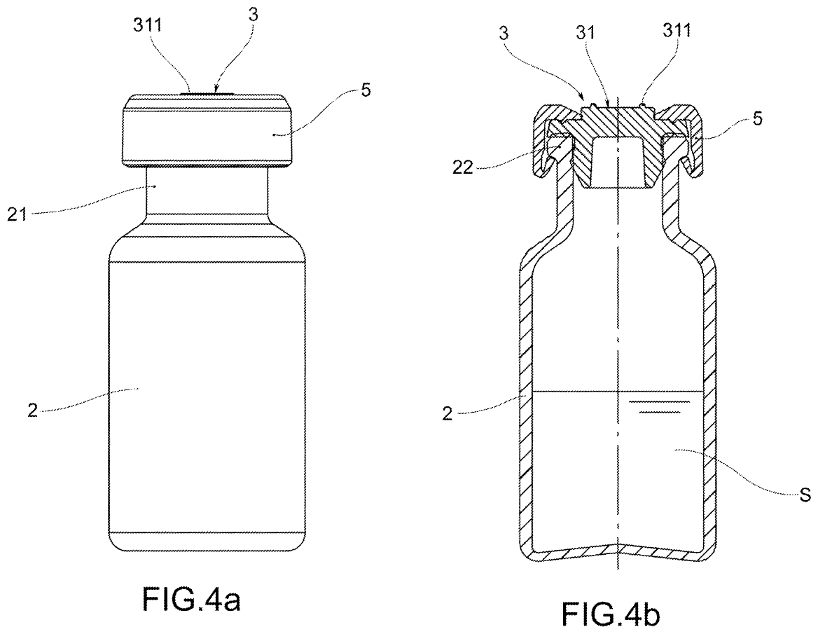

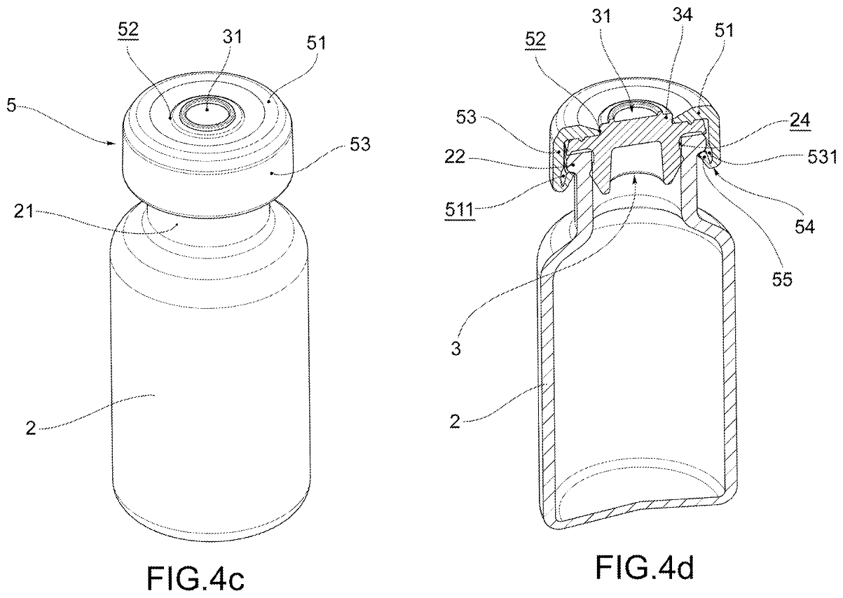

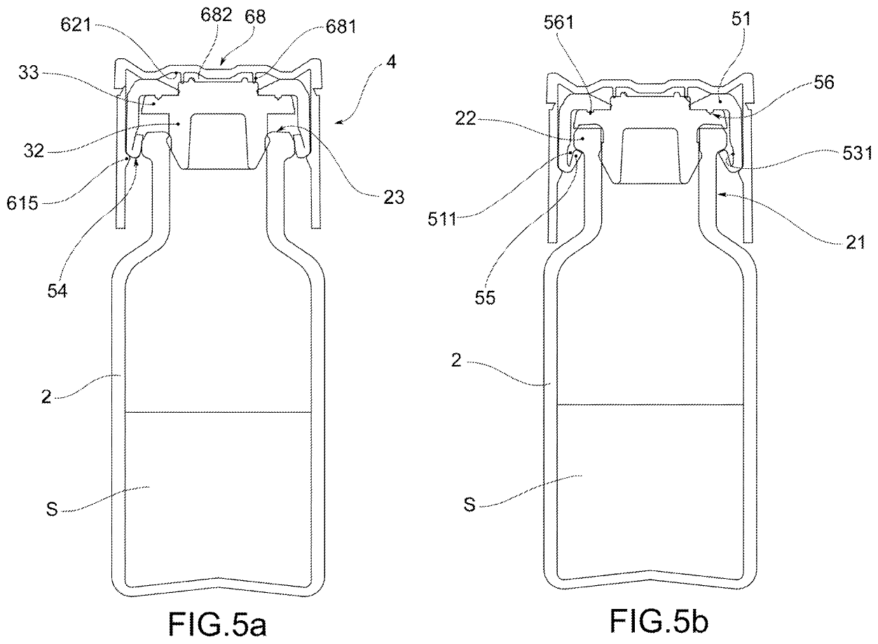

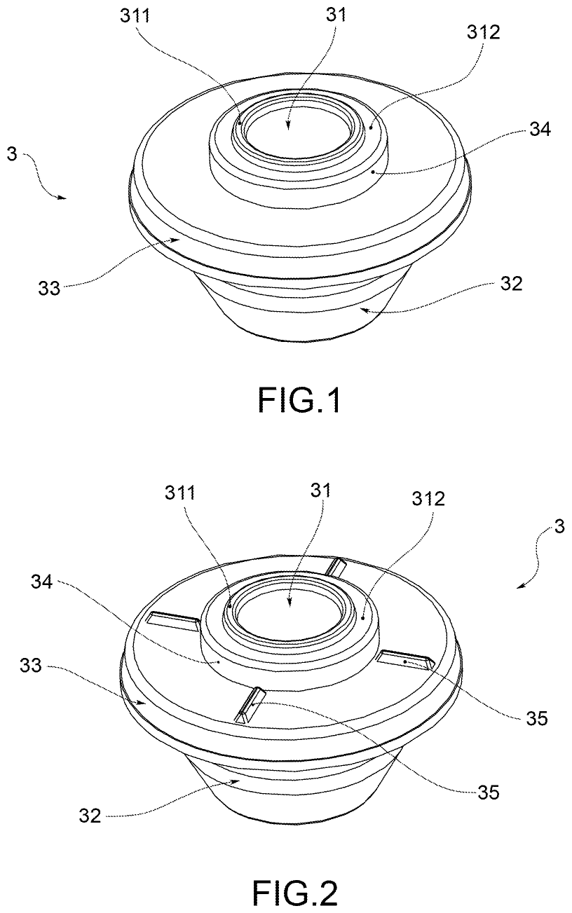

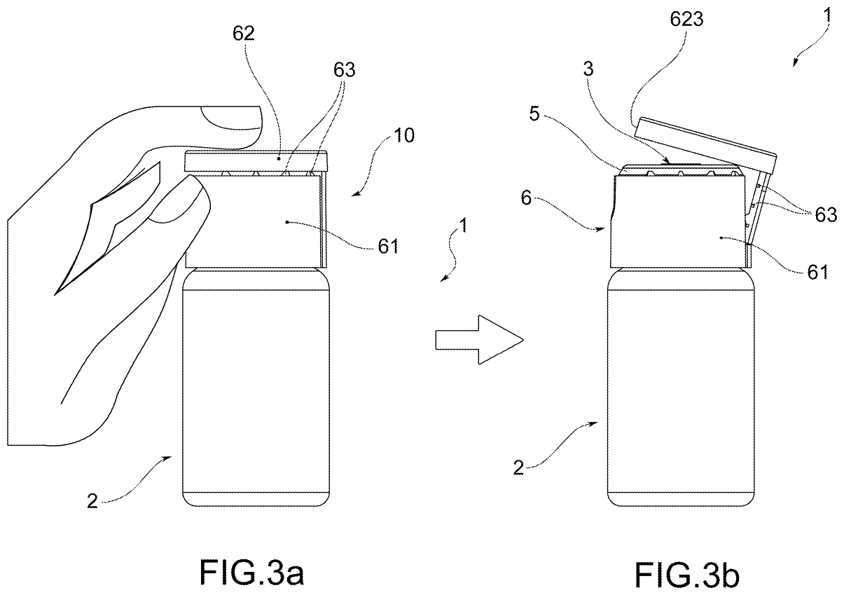

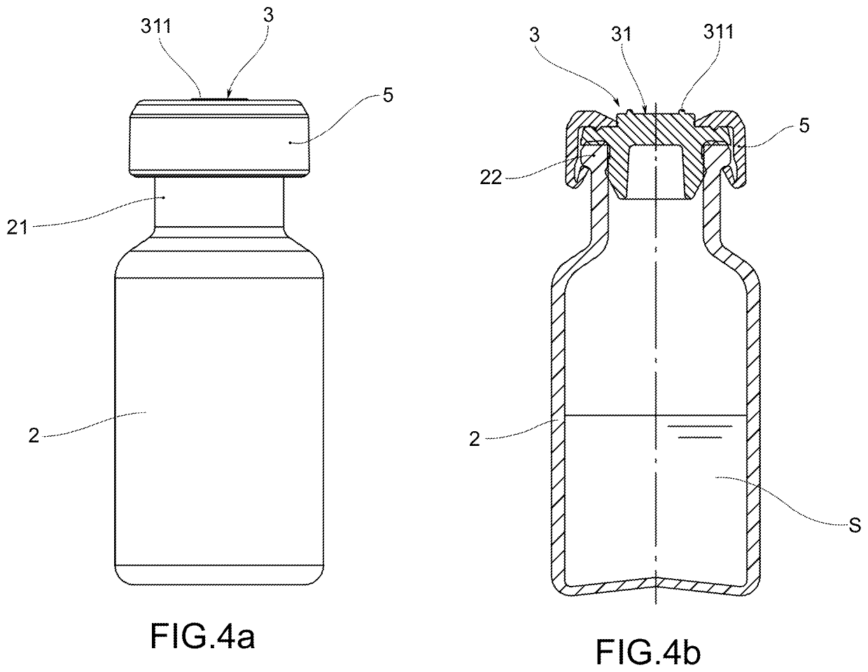

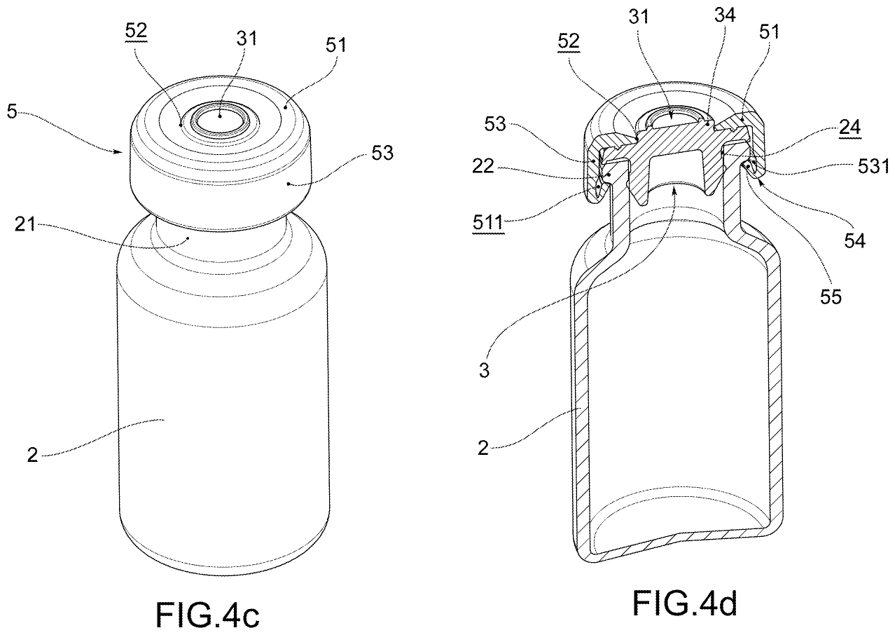

FIGS. 4A and 4B show a front view and a sectional view, respectively, of the container of FIG. 3A after an outer cap of the closing device has been completely removed;

FIGS. 4C and 4D show an axonometric view and an axonometric sectional view, respectively, of the container of FIG. 3A after an outer cap of the closing device has been completely removed;

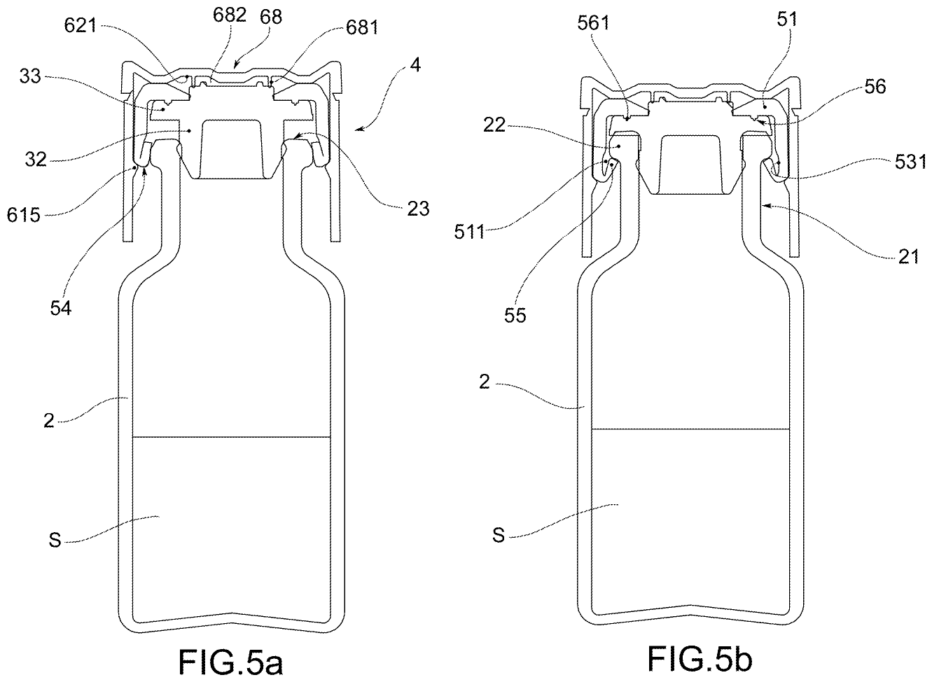

FIGS. 5A and 5B show the assembly steps of the container of FIG. 3A, and in particular the assembly of the closing device comprising a rubber sealing element according to the present invention on a bottle.

In the accompanying figures, the reference numeral 1 indicates a container for parenterally administrable pharmaceutical products comprising a bottle 2 closed by a closing device 10 made of a sealing element 3, for example made of rubber, and a safety cap 4, for example made of plastic, partially tear-off and adapted to guarantee the authenticity of the container, highlighting any tampering.

The safety cap 4 completely covers the sealing element 3 and may be removed at least partially in order to expose a pierceable portion 31 of such sealing element 3 intended to be pierced by the needle of a syringe in order to be able to withdraw the pharmacological solution S contained in the bottle 2.

The bottle 2 is intended to contain a parenterally administrable pharmacological solution S and is provided with a neck 21 ending superiorly in an edge 23 which defines the mouth 24 of the bottle itself. The edge 23 is provided with a ridge 22 protruding radially from the neck 21 and having an outer diameter greater than the outer diameter of the neck 21.

In the container 1, the mouth 24 of the bottle 2 is closed by a sealing element 3.

The sealing element 3, shown in detail in FIGS. 1 and 2 and described below, is a rubber cap which seals in a sterile manner the contents of the bottle 2 from the environment, and which may be pierced by a hypodermic needle, not shown in the drawings, to remove the pharmacological solution S from the container 1.

The sealing element 3 is covered by the safety cap 4 which, in addition to contributing to the sealing of the container 1, also has a “tamper evident” function, highlighting any tampering with the container itself.

The safety cap 4 comprises two elements and is made entirely of plastic. Preferably, the safety cap 4 consists of only two elements.

The safety cap 4 comprises:
an inner cage 5, adapted to partially cover the sealing element 3 leaving at least one of its pierceable portions 31 exposed, and adapted to keep the sealing element 3 engaged inside the mouth 24 of the bottle 2 in the correct sealing position even when using the container 1,
an outer cap 6, adapted to completely cover the sealing element 3 and the inner cage 5 until the moment of use of the container 1, when said outer cap 6 may be removed by tearing to expose the pierceable portion 31 of the sealing element 3 intended to be pierced by the needle of a syringe to be able to withdraw the pharmacological solution S contained inside the bottle 2.

The inner cage 5 comprises a head 51, provided with a central opening 52 which allows access to the pierceable portion 31 of the sealing element 3, below which a cylindrical skirt 53 extends, ending in a lower edge 54 at which retaining means 55 are provided. In fact, the inner cage 5 of the safety cap 4 snap-engages below the ridge 22 of the neck 21 of the bottle 2 by means of said retaining means 55.

The retaining means 55 are at least one hook-like ridge facing towards the inside of the inner cage 5.

Preferably, the retaining means 55 are connected to the skirt 53 through the lower edge 54, which preferably has a curvilinear profile to further increase the flexibility of the retaining means 55.

The retaining means 55 are provided with a bearing space 551 defined between the retaining means itself and the inner surface of the skirt 531. As may be seen in FIGS. 5A and 5B, during the positioning of the inner cage 5 on the neck 21 of the bottle 2, the retaining means 55 compress, approaching the inner surface of the skirt 531 and occupying the bearing space 551, without deforming the inner cage 5. This solution facilitates the sliding of the retaining means 55 at the ridge 22 of the bottle 2, until the snap engagement underneath said ridge 22 is obtained.

In summary, therefore, the inner cage 5 of the safety cap 4 is provided with highly flexible retaining means 55, to facilitate the assembly steps of the container 1, and with a high clamping force, to best retain the inner cage 5 on the neck 21 of the bottle 2. Advantageously, therefore, by virtue of the retaining means 55 of the inner cage 5, once the snap coupling on the neck 21 of the bottle 2 has been obtained, no further fixing or retaining element will be required to keep the sealing element 3 firmly in the closed sealing position of the mouth 24 of the bottle 2 even if the outer cap 6 is completely removed by tearing.

Preferably, the inner cage 5 is provided with thrust means 56 of the sealing element 3, arranged below the head 51, shaped to provide a compensation mechanism for the coupling tolerances between the sealing element 3, the inner cage 5 and the ridge 22 of the neck 21 of the bottle 2. In fact, the rubber sealing element 3 and the glass ridge 22 are elements characterized by high variations in the dimensional tolerances that the inner cage 5 should compensate for to ensure the correct pulling force below the ridge 22 against any tampering.

Preferably, the thrust means 56 comprise at least one continuous annular protrusion 561 at the inner surface of the head. The thrust means 56 have a profile ending in a tip suitable for sinking at least partially into the sealing element 3. The thrust means 56 of the inner cage 5 will be able to exert, through the tip, a minimum thrust on the sealing element 3 even in the case of minimum tolerances of the glass and the rubber. At the same time, the maximum thrust exerted in the case of maximum tolerances of the glass and the rubber will not be excessive since the tip, having a very small section, will sink more into the sealing element 3.

The outer cap 6 is provided with tear-open means by means of which it may be opened to expose the sealing element 3.

The outer cap 6 is formed by a band 61, preferably cylindrical, closed at the top by a cover 62, preferably disc-shaped.

Preferably, the band 61 is elongated, i.e. it extends to cover the entire neck 21 of the bottle 2, as seen in FIG. 3A. This solution considerably reduces the risks of tampering as it is more difficult to access underneath the safety cap 4 to try to tamper with it.

The cover 62 is connected to the band 61 by means of weakening 63 at an outer perimeter 623 of the spread cover. Such weakenings 63 are suitable for being torn apart to separate the cover 62 from the band 61, thus opening the outer cap 6 at the top to allow access to the sealing element 3.

The weakenings 63 are a plurality of uniformly distributed thin bridges, as shown in FIG. 1, or necking lines of the material, or pre-cuts, or grooves.

Preferably, the band 61 also has weakenings 63 which facilitate the complete removal of the outer cap 6 of the safety cap 4 from the container. Advantageously, by virtue of a completely removable outer cap 6, even in the presence of a deliberately elongated band 61 covering the entire neck 21 of the bottle 2, it is possible to maintain full visibility of the neck itself, as may be seen in FIG. 4a, useful when the bottle 2 is turned upside down during the final withdrawal of the pharmacological solution by means of a syringe and the residual solution is collected precisely at said neck.

Preferably, the outer cap 6 is provided with means 68 for protecting the sealing element 3, arranged under the cover 62. Preferably, the protection means 68 are in the form of a projection 681, preferably annular and continuous, at an inner covering surface 621. Such projection 681 delimits a chamber 682, visible in FIG. 5A. When the closing device 10 is assembled, the protection means 68 are arranged in such a way that the projection n 681 abuts against the sealing element 3 outside the pierceable portion 31, which is therefore arranged inside the chamber 682. Therefore, the inner covering surface 621 of the outer cap 6 is always raised with respect to the pierceable portion 31 of the sealing element 3 to avoid the contamination thereof.

As may be seen in FIG. 5B, the band 61 of the outer cap 6 has a certain height adapted to completely cover the inner cage 5 and the entire neck 21 of the bottle 3.

The outer cap 6 is fixed to the bottle 2 by means of the interposition of the inner cage 5. The outer cap 6 of the safety cap 4 is in fact snap-engaged under the lower edge 54 of the inner cage 5 by means of coupling means 615.

The coupling means 615 are at least one relief protruding inside the band 61. Preferably, the coupling means 615 are in the form of a continuous annular relief, protruding from the inner surface of the band 611.

The sealing element 3, shown in two embodiment variants in FIGS. 1 and 2, is a rubber cap having a cap head 33, preferably disc-shaped, below which the cap body 32, preferably cylindrical, extends.

The cap body 32 is intended to fit inside the neck 21 of the bottle 2, while the cap head 33 is intended to rest against the edge 23 to close the mouth 24 of the bottle itself.

The sealing element 3 is provided with a pierceable disc-shaped portion 31, arranged centrally to the cap head 33 and defined inside an annular edge 311.

The pierceable portion 31 is made on a disc-like elevation 34 of the cap head 33. That is to say that the cap head 33 defines a head plane, and that the pierceable portion 31 is arranged on a raised plane with respect to the head plane and defined by the elevation 34. As may be seen in FIGS. 4C and 4D, when the closing device 10 is assembled, the elevation 34 is inserted and retained inside the central opening 52 of the head 51 of the inner cage 5. The sealing element 3 is therefore kept in position in the inner cage 5 by means of a frictional engagement obtained through the elevation 34, which is a disc portion more resistant to deformation than the annular edge 311 which defines the pierceable portion 31. This guarantees a safer engagement between the sealing element 3 and the safety cap 4 during the assembly step on the bottle 2.

The pierceable portion 31 is centrally arranged on the elevation 34. The elevation 34 has a larger diameter than the diameter of the pierceable portion 31 so that, outside the annular edge 311, there remains an annular safety edge 312 on which the protection means 68 of the outer cap 6 may engage without risk of contamination of the pierceable portion 31.

Preferably, the pierceable portion 31 is arranged flush with the head 51 of the inner cage 5. Preferably, the annular edge 311 which defines the pierceable portion 31 projects above the head 51 of the inner cage 5.

Preferably, the cap body 32 has a maximum diameter of between 7 mm and 8 mm, preferably 7.75 mm.

Preferably, the cap head 33 has a maximum diameter of between 11 mm and 12 mm, preferably 11.4 mm.

Preferably, the elevation 34 has a diameter of between 5.5 mm and 6.5 mm, preferably 6 mm.

Preferably, the safety edge 312 extends by about 1 mm outside the annular edge 311 of the pierceable portion 31.

Preferably, the elevation 34 protrudes by about 1 mm from the plane defined by the cap head 33.

Preferably, the height of the elevation is about ⅔ of the height of the cap head 33.

Preferably, the annular edge 311 which defines the pierceable portion 31 protrudes superiorly by between 0.2 mm and 0.4 mm, preferably 0.3 mm, from the plane defined by the elevation 24.

Advantageously, the elevation 34 allows the pierceable portion 31 to be positioned higher. In fact, the pierceable portion 31 is on a raised plane with respect to the head plane. Therefore, once the outer cap 6 has been removed, as seen in FIG. 4C, the pierceable portion 31 of the sealing element 3 is accessible through the central opening 52 of the inner cage 5. Unlike the solutions of the prior art, the pierceable portion 31 is positioned at the entrance to the central opening 52 and is thus easily accessible for the necessary disinfection by the operator before using the sampling needle.

In an embodiment, shown in FIG. 2, the sealing element 3 is provided with a plurality of thrust reliefs 35 arranged radially on the cap head 33, uniformly distributed about the pierceable portion 31. For example, the sealing element 3 is provided with four thrust reliefs 35. The thrust reliefs 35 of the sealing element 3 are adapted to collaborate with the thrust means 56 of the inner cage 5.

Preferably, the thrust reliefs 35 protrude superiorly by between 0.2 mm and 0.4 mm, preferably 0.3 mm, from the plane defined by the cap head 33.

The object of the present invention is also a container 1 for parenterally administrable pharmaceutical products provided with a closing device 10 comprising a sealing element 3 as described above, as well as a partially tear-off safety cap 4.

As far as the materials are concerned, the technical solutions described above are applied to plastic closing devices 10, to glass or plastic bottles 2, to sealing elements 3 in thermosetting rubber or thermoplastic rubber.

Innovatively, a rubber sealing element according to the present invention, intended for a plastic closing device for containers for parenterally administrable drugs, allows all the intended objects as described above to be achieved in a particularly effective manner.

Advantageously, a rubber sealing element according to the present invention is easily accessible for the necessary disinfection.

Advantageously, a rubber sealing element according to the present invention is provided with a retaining system under the cap which is effective and safe.

It is clear that those skilled in the art may make changes to the sealing element and to the container described above, all falling within the scope of protection as defined in the following claims.

The invention claimed is:

1-10. (canceled)

11. A rubber sealing element for a plastic closing device for parenterally administrable drugs, the rubber sealing element comprising:
a discoidal cap head under which a cylindrical cap body extends, said discoidal cap head defining a head plane;
a pierceable portion arranged in a center of the discoidal cap head, said pierceable portion being arranged on a raised plane with respect to the head plane;
wherein the pierceable portion is arranged on an elevation protruding superiorly and centrally from the discoidal cap head;
wherein the pierceable portion is arranged inside an annular edge, and wherein said elevation has a diameter greater than a diameter of the pierceable portion so as to define, outside the annular edge, a safety edge about said pierceable portion.

12. The rubber sealing element of claim 11, wherein the discoidal cap head has a diameter between 11 mm and 12 mm, and the elevation has a diameter between 5.5 mm and 6.5 mm.

13. The rubber sealing element of claim 11, wherein the elevation protrudes about 1 mm from the head plane defined by the discoidal cap head.

14. The rubber sealing element of claim 11, wherein a height of the elevation is about ⅔ of a height of the discoidal cap head.

15. The rubber sealing element of claim 11, further comprising thrust reliefs protruding radially from the discoidal cap head, uniformly distributed about the pierceable portion.

16. The rubber sealing element of claim 11, wherein the safety edge extends by about 1 mm outside the annular edge of the pierceable portion.

17. The rubber sealing element of claim 11, wherein the annular edge protrudes superiorly by between 0.2 mm and 0.4 mm from a plane defined by the elevation.

18. The rubber sealing element of claim 11, wherein the annular edge protrudes superiorly by 0.3 mm from a plane defined by the elevation.

19. A container for parenteral pharmaceutical products, the container comprising:
a bottle provided with a neck;
a plastic closing device comprising:
an inner cage provided with a central opening and ending in a lower edge, retaining means for permanent snap engagement on the neck of the bottle being provided at the lower edge;
an outer cap, snap-engaged below the lower edge of the inner cage through internally protruding coupling means, provided with tearable weakenings to allow removal of the outer cap by tearing; and
a rubber sealing element comprising:
a discoidal cap head under which a cylindrical cap body extends, said discoidal cap head defining a head plane;
a pierceable portion arranged in a center of the discoidal cap head, said pierceable portion being arranged on a raised plane with respect to the head plane;
wherein the pierceable portion is arranged on an elevation protruding superiorly and centrally from the discoidal cap head;
wherein the pierceable portion is arranged inside an annular edge, and wherein said elevation has a diameter greater than a diameter of the pierceable portion so as to define, outside the annular edge, a safety edge about said pierceable portion,
the rubber sealing element being housed inside the inner cage so that, once the outer cap has been removed, the pierceable portion of said rubber sealing element is accessible from outside through the central opening of the inner cage.

20. The container of claim 19, wherein the pierceable portion is arranged flush with the inner cage.

21. The container of claim 19, wherein the elevation is inserted and retained within the central opening of the inner cage.
